(19) United States
(12) Patent Application Publication
(10) Pub. No.: US 2016/0042148 A1
(43) Pub. Date: Feb. 11, 2016

(54) Therapeutic Equivalent and Healthy Alternative Recommendation System

(71) Applicant: Safeway Inc., Pleasanton, CA (US)

(72) Inventor: Kent Bradley, Pleasanton, CA (US)

(21) Appl. No.: 14/633,625

(22) Filed: Feb. 27, 2015

Related U.S. Application Data
(60) Provisional application No. 62/033,983, filed on Aug. 6, 2014.

(51) Int. Cl. G06F 19/00

(52) U.S. Cl. CPC G06F 19/3456

(57) ABSTRACT

A system for recommending health care options that receives a request for a recommendation of at least one good and retrieves a plurality of information from a plurality of servers, wherein the server computer is one of the plurality of servers. The system analyzes the request along with a customer profile and the plurality of information to determine a subset of the plurality of goods corresponding to the request for the recommendation at least one good and receives a purchase request for at least one of the subset of the plurality of goods. The customer profile may be updated with at least the purchase request.

### CROSS-REFERENCE TO RELATED APPLICATIONS

This application claims priority to and incorporates in its entirety U.S. Provisional Application 62/033,983, “Therapeutic Equivalent and Healthy Alternative Recommendation System,” filed Aug. 6, 2014.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Various medications may be prescribed or recommended to patients for different health conditions. Patients may fill these prescriptions or buy this medication from different retail or online vendors and the medications may be available in various dosages and delivery methods.

### SUMMARY

In an embodiment, a system for recommending health care options comprising: a server computer comprising a memory, a processor, and an application executable by the processor that causes the application to: receive a request for a recommendation of at least one good, wherein the request is associated with a customer profile, wherein the customer profile comprises a plurality of prescription medicines prescribed to a customer associated with the customer profile; retrieve a plurality of information from at least a plurality remote servers separate from the server computer, wherein the plurality of information is associated with a plurality of goods, wherein the plurality of goods comprises prescription medicines and over-the-counter medicines; analyze at least the request, the customer profile, and the plurality of information to determine a subset of the plurality of goods, wherein the subset of the plurality of goods comprises goods corresponding to the request for the recommendation at least one good; display a plurality of recommendations comprising the subset of the plurality of goods comprising at least one price point determined based upon the application applying a plurality of rules associated with an insurance provider associated with the customer profile; receive a purchase request for at least one of the subset of the plurality of goods; and update the customer profile with at least the purchase request.

In an alternate embodiment, a health care recommendation system comprising: a server computer comprising a memory, a processor, and an application executable by the processor that causes the application to: receive a request for a recommendation of goods, wherein the request is associated with a customer profile, wherein the customer profile comprises a plurality of prescription medicines prescribed to a customer associated with the customer profile; retrieve a plurality of information from a plurality of servers, wherein the server computer is one of the plurality of servers, and wherein at least some of the plurality of servers are remote servers, wherein the plurality of information is associated with a plurality of goods, wherein the plurality of goods comprises prescription medicines, over-the-counter medicines, vitamins, minerals, and perishables, wherein the prescription medicines comprise brand name and generic medicines; compare a price point associated with a prescription medicine prescribed to the customer and a price point of a good of the plurality of goods, wherein the at least one good comprises a brand name medicine, a generic medicine, a vitamin, a mineral, a perishable, and an over-the-counter medicine; compare a health benefit associated with the prescription medicine prescribed to the customer and a price point of a good of the plurality of goods, wherein the at least one good comprises a brand name medicine, a generic medicine, a vitamin, a mineral, a perishable, and an over-the-counter medicine; recommend at least one of the brand name medicine, the generic medicine, the vitamin, the mineral, the perishable, and the over-the-counter medicine; receive a purchase request for the at least one recommended good; and update the customer profile with at least the purchase request.

In an alternate embodiment, a system for recommending health care options, comprising: a server computer comprising a processor, a memory, and an application executable by the processor that causes the application to: receive a request for a recommendation of goods, wherein the request is associated with a customer profile, wherein the customer profile comprises a plurality of prescription medicines, and wherein each prescription medicine of the plurality of prescription medicines is associated with at least one health condition; retrieve a plurality of information from a plurality of servers, wherein the server computer is one of the plurality of servers, and wherein at least some of the plurality of servers are remote servers, wherein the plurality of information is associated with a plurality of goods, wherein the plurality of goods comprises prescription medicines and over-the-counter medicines; analyze the request, the customer profile, and the plurality of information to determine a subset of the plurality of goods, wherein the subset of the plurality of goods comprises goods corresponding to the request for the recommendation of goods; recommend the subset of the plurality of goods, wherein each good of the subset of goods is associated with improving the at least one health condition corresponding to the goods in the recommendation request; receive a purchase request for at least one of the subset of the plurality of goods; and update the customer profile with at least the purchase request.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is an illustration of a system that may be capable of executing according to certain embodiments of the present disclosure.

FIG. 2 is a flow chart of a method of obtaining recommendations for goods according to an embodiment of the disclosure.

FIG. 3 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Systems and methods discussed herein relate to a program that allows employers, including but not limited to a self-insured employer, to select specific categories of drugs that will be targeted for reference pricing and the selection of the lowest cost therapeutically equivalent drug within a specific therapeutic category by a specific dose. This may be accomplished as discussed herein with the integration of a plurality of data bases from different sources to create a customized master price file based on the selected therapeutic categories for use by a pharmacy benefit manager or other appropriate party to administer the program.

Systems and methods disclosed herein relate to the comparison of prescription medication pricing and additionally relate to a whole-health approach and related analysis where not only generic alternatives to medication but also vitamins, minerals, and consumables may be presented as alternatives or supplements to a prescription regimen. In particular, the disclosure is related to comparing a user's prescribed medicines to Orange Book-approved therapeutic equivalents (“generic” drugs), over-the-counter medicines (“OTC”), and holistic remedies including vitamins, minerals, and food/beverage products in order to determine whether there is a generic equivalent or another alternative or supplement to a prescribed medication. In an embodiment, the systems and methods discussed herein may provide a coverage analysis for a user with respect to one or more insurance plans to enable the user to determine not only the recommended or approved medicines and health alternatives available, but also the cost differences between options based upon the coverage offered by insurance companies. In some embodiments, the cost and/or coverage may be based in part off of a therapeutic effect associated with a recommended or prescribed product.

It is understood that the Orange Book is a list maintained by the United States Food and Drug Administration (“FDA”) to identify drugs (which may be referred to as “brand” or “brand name” drugs) approved for various indications based upon the safety and efficacy of the use of the drug for an indication. The Orange Book is updated by the FDA on a periodic basis and contains information about patents on drugs that the drug's manufacturer submits protect the listed drugs. In addition, the Orange Book lists therapeutic equivalents (generic drugs) that are approved for each of the drugs. A customer may want a generic equivalent due to lower pricing, and/or may be interested in supplementing their prescription medication with vitamins, minerals, and food/beverage choices in an effort to cure/remedy/reduce a health care condition, in particular a chronic or progressive condition.

Various embodiments of the system disclosed herein may comprise components including mapping software, analytic tools, reporting tools, customer interfaces, communication tools, and modeling capabilities. For example, an embodiment of the system may comprise mapping software that merges a pharmacy benefit manager formulary and pricing file with, for example, a Destination Rx® Drug Compare tool or similar tool that provides dose specific drug to drug therapeutic matching. This mapping software creates a new pricing file that is specific to a client's chosen formulary, and the pricing file may be capable of being sent electronically to a PBM for administering the new benefit plan design. This benefit plan design involves the use of a lowest cost alternative drug and a differential payment structure to the member based on a defined contribution by the health plan up to the reference price. In some embodiments, an analytic tool that provides an estimate of savings based on specific formulary and number of therapeutic categories selected that can be provided to a client for decision making. A reporting tool may be employed that may provide an analysis of spend specific to a client's formulary and claims history involving volume of scripts by drug and dose.

In one embodiment, a customer-facing “medicine cabinet” that is capable of loading all individual drugs based on claims history and communication of lowest cost alternatives to the member via a web-enabled tool based on specific client plan design and formulary. The system may also comprise communication functionalities including faxing, emailing, text messaging, or other messaging that may be employed to communicate to member's prescribing provider of lowest cost alternatives specific to the member via a web portal. In some embodiments, the system may comprise a predictive modeling module that may analyze the behavior of populations of the system in order to predict future requests and/or spending.

In addition to therapeutic equivalents, the application may also analyze and recommend biosimilar agents (including follow-ons and interchangeables as appropriate) as well as specialized (custom formulated) drugs to select the highest value/lowest cost alternatives based on a therapeutic impact of each alternative. The location of the available and/or recommended products and care, e.g., the proximity within which a particular product or form of care is available based upon a selected customer location or a customer location associated with a customer profile may also be considered during the analysis. This analysis may be employed to determine an overall lowest (or lower) cost that bundles medical and pharmacy spending for drugs where the route to and place of administration act as cost variables.

In some embodiments, an insurer or other health provider may have access to a dashboard that may be used to highlight to payors and benefit administrators which plan participants could benefit from direct outreach for medication therapy management or case management, this dashboard may be used to model impacts of benefit design structure on user adoption and overall costs.

A gamification platform may be employed to create alternate incentives for a lower or lowest cost alternative beyond a reference price design, where the reference may be set by the provider or by the consumer. This platform may comprise a points engine that may link to the customer account/profile and provide incentives for users to earn points for prices, cash awards, drawing entries, and other rewards, including insurance incentives and/or discounts. An incentive engine, which may be part of the gamification platform or separate from it, may present OTC or consumable options along with incentives in order to drive behavior change. This incentive engine may be in communication with a plurality of insurance companies in order to provide information about insurance-related discounts and incentives. For example, a user prescribed a statin may be notified of a lower or lowest cost alternative for the prescribed statin based upon a request or based upon a preference for notifications in the user's customer profile. The user may receive a coupon or a link to a coupon on a portable electronic device or as a hard copy that acts as an incentive to purchase this alternative. The same user may also receive a coupon for a high-fiber food product as an incentive to purchase that product in an effort to drive behavior change. The gamification platform may track which products are recommended and which products are purchased, the frequency a product is recommended, the frequency with which a product is purchased, as well as other metrics associated with the system discussed herein.

In an embodiment, a customer may request a prescription refill or a recommendation for a generic medication and/or alternative health care options. The customer may send this request from a mobile communication device or other computing device including an in-store kiosk. A customer's profile, which may be stored on a server computer owned or maintained by a store or store chain that comprises a pharmacy, may comprise a plurality of prescribed medications as well as corresponding medical (health) conditions, allergies, and other information. The application discussed herein may analyze the customer's request and/or profile in light of therapeutic equivalents and alternative remedies to recommend and present alternatives to the prescription medication. The goods available for purchase may include the prescription medicine, generic equivalents, and holistic/alternative remedies including vitamins, minerals, and food/beverage products which may be referred to as consumables or perishables. In some embodiments, a customer may be able to select a specific geographic area, either for convenience of pickup, or to determine if there are alternative health options available in a particular area of the world that may not be available in their own, for example, if someone is traveling to an area that is known for Ayurvedic techniques or a certain low-sugar, high fiber fruit such as the star fruit.

In some embodiments, combinations of these items may be recommended, and in alternate embodiments, off-label usage may be taken into consideration for the recommendations. The information presented to the customer may indicate that the generic medication is less expensive, or that the prescription medication is less expensive, which may depend in some embodiments upon the amount of insurance coverage, if any, available for the recommended items, based upon at least one insurance plan associated with the customer's profile. If items are selected for purchase from the information that is presented to the customer, the customer's profile may be updated with the purchase and/or the information that was presented to the customer. In some embodiments, a refill reminder may be set by the system or by the customer which may also comprise a component that alerts the customer's doctor when a new prescription is needed or when a vitamin, mineral, over-the-counter, or consumable purchase may be about to run out. In some cases, a new prescription from a doctor may be required so that the customer can order the generic option. In that event, the system may contact the prescribing physician to obtain this new prescription.

In one embodiment, a customer may request a recommendation for a cholesterol medication. An application may receive this request and retrieve therapeutic equivalents of the requested cholesterol medication along with the associated price points (before and after any insurance payment is applied), and other information such as interactions and counter indications and compare this retrieved information with the customer's profile against, for example, interactions, allergies, insurance (e.g., what and how much is covered) and any preferences related to refill time period (30 days, 90 days, etc.). In addition, the application may also review alternative supplements and/or remedies such as fiber supplements, fibrous vegetables, minerals, and/or vitamins.

In another example, a customer may request a prescription refill and the application may receive this request and ask the customer if they would like to see a comparison of brand name and generic medications. In one embodiment, the application may also or in the alternative ask if the customer would like to see other health opportunities related to the improvement of the health condition associated with the prescription refill. This may be referred to as a “healthy living suggestion” or a preventive measure. In some embodiments, this “health living suggestion” option may be a stand-alone option for the user to select, i.e., an option that may be selected without a prescription request or recommendation request, for example, if a consumer is interested in researching preventive or corrective measures for health conditions that may run in their family or in which they are otherwise interested. The application may review the customer's profile information and the inventory information regarding various products in order to recommend health supplements or alternatives. For example, if a customer indicates by a prescription refill request or other request associated with a sinus health condition, the application may recommend a dairy-free or reduced dairy diet in addition to saline solution and/or a traditional neti pot. In various embodiments, different combinations of generic medicine, OTC medicine, consumables, and even alternate brand medications as discussed below may be recommended by the application to the customer.

In some embodiments, the analysis of the requested medication, the customer profile, available therapeutic equivalents, and alternative remedies may also include an analysis of the packaging, dosage delivery methods, and possible combinations of medication available. For example, if a request is made for a blood pressure medication and a diuretic, the system may present at least one option for a combination medication that can replace both medicines, and may offer the option of contacting the physician directly to obtain a prescription for this option. The packaging and dosage delivery methods may be relevant, for example, if there is an option between an oral dosage and an injectable, a patch and a gum, or between a vial and a pen delivery system. In some embodiments, the storage method, i.e., refrigeration, may also be analyzed and displayed to the customer.

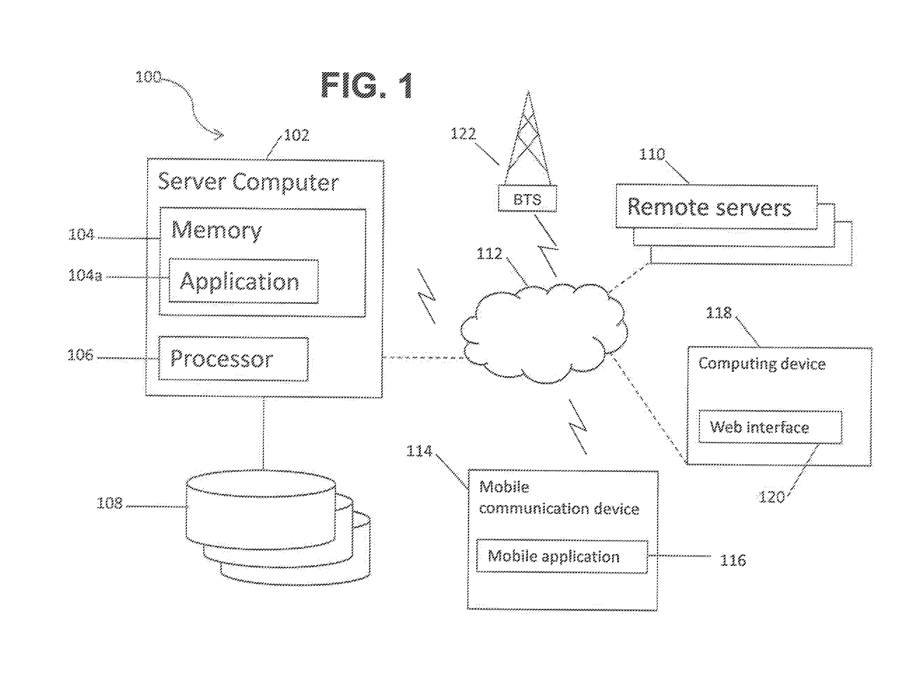

FIG. 1 illustrates system 100 which may be capable of executing according to certain embodiments of the present disclosure. In an embodiment, system 100 comprises a server computer 102, a plurality of data stores 108 stored on the server computer 102, a plurality of remote servers 110, a network 112, and a base station transceiver (BTS) 122. The server computer 102 comprises a processor 106 and a memory 104 that may store an application 104a that may be executable by the processor 106. The application 104a may be a single application or may, in some embodiments, represent a plurality of applications that retrieve information, analyze information, present information, receive requests for recommendations and purchases, receives selections of purchases, and can adjudicate the purchase by communicating with at least one insurance company associated with at least one of the remote servers 110. The plurality of data stores 108 may comprise a plurality of information about customers of a business entity such as a pharmacy, grocery store, or big-box store. The customer information may be referred to as a customer profile or a customer account and may comprise for example, a customer's name, address, email address, contact phone numbers, allergies, prescription medications, billing information, product viewing history, and product purchase history. In some embodiments, a family account may list multiple sets of customer information which may be referred to as a plurality of customer profiles tied to a single account or to a single insurance plan or suite of plans under a single insurer. This may be the case, for example, when someone is responsible for the health care of a child, disabled adult, elder family member, or other party who may desire or be mandated by a court or other authority to have assistance with their health care decisions and administration.

Turning back to the system 100, the plurality of remote servers 110 may be in communication with the server computer 102, and may be specifically configured to communicate at least with the application 104a to receive information about selected products and send to the application 104a, based upon the received information, the coverage information (covered price points) of the selected product(s). In an embodiment, the plurality of remote servers 110 comprises servers from different insurance companies, pharmacies, or other health care providing and supporting entities. It is understood that any information shared as a part of the systems and methods discussed herein may be shared in a way that is in compliance with the Health Insurance Portability and Accountability Act of 1996 (HIPAA). Communication between at least some of the plurality of remote servers 110 and the server computer 102 may employ the network 112, and may enable the server computer 102 to “see” a more complete picture of the health conditions associated with the customer, for example, in the event that multiple insurers or stores are employed or have been previously employed by the customer to fill prescriptions.

In an embodiment, the application 104a receives a request for a recommendation of at least one good from a computing device 118 or a mobile communication device 114. The request may be for a prescription medication refill, a pricing comparison for a medicine or medicines, or a general request for health care information related to a concern or health condition. In one example where the request is for a prescription medication including a brand name medication, and the customer may be interested in determining what other options there are for the requested medication. These options may include a therapeutic equivalent as identified in the Orange Book, over-the counter medicine(s), or vitamin/mineral/consumable that may also be appropriate for the health condition associated with the requested good or goods. A consumable may be a food or beverage and the application 104a may ultimately either recommend what to consume or what not to consume, and in some embodiments both the “dos” and “don'ts” may be presented to the customer as discussed herein.

The computing device 118 may be a desktop computer, kiosk, or other device that comprises a web interface 120 and compatible software to communicate with the server computer 102 at least by way of the network 112. The mobile communication device 114 may be a mobile phone, tablet, personal digital assistant (PDA), or other device that comprises a mobile application 116 capable of communicating with the server computer 102. In some embodiments, a customer may first log in to their customer account prior to making the request, and in alternate embodiments, a mobile application or web portal may have been previously configured to recognize the customer without an additional sign-on. In another embodiment, a customer may have a fob or card or other device that can be swiped or scanned to retrieve account information.

The application 104a may receive the request and retrieve information from at least some of the plurality of remote servers 110 and/or the data stores 108. The plurality of remote servers may comprise information including therapeutic equivalents from the Food and Drug Administration's Orange Book as well as health information about minerals, vitamins, and consumables (food and beverage). The application 104a may compare and analyze the request with the information retrieved in order to generate a list or a matrix of pricing and dosage options. The analysis may comprise a comparison of price points, dosages, side effects, and other factors and may recommend and display for comparison generic medications and brand medications, and may in some embodiments recommend supplements such as vitamins, minerals, or consumables in addition to or instead of the medications.

In alternate embodiments, the analysis may also comprise a comparison between different medications' delivery methods (vial or epi-pen) or packaging (eco-friendly, travel-friendly, etc.) and may also compare any restrictions (refrigeration requirements) and warnings including drug interactions against the information in the customer profile. In one embodiment, the application 104a generates a list or a matrix of recommendations and presents this information to the customer. The application 104a may subsequently receive a purchase request from the computing device 118 or the mobile communication device 114 for one or more recommended goods. The information generated and presented to the customer (e.g., the recommended products) may be ranked by price, by popularity, or in a manner that indicates which combinations of presented goods are available and in which quantities those combinations should be ingested by the customer. For example, the matrix may list brand name and generic cholesterol medications in addition to options for taking a fiber supplement, and may rank the listed products according to the cost of the products before and/or after insurance coverage is applied. If the application 104a receives a purchase request for one of the recommended goods, the application 104a may also update the customer information (e.g., the customer profile/account) associated with the purchasing customer to reflect the purchase and/or to reflect the recommendations list. In addition, the customer may elect to save a product from the recommendations list for later purchase.

In an embodiment, the system 100 is a dynamic system, receives and retrieves updates regarding Orange Book new listings, removals, and therapeutic equivalents on a real-time basis and/or a predetermined basis, for example, at predetermined intervals, for example, in response to updates on remote servers by government entities or private entities such as insurance companies, through a manual push, or in combinations thereof. In an embodiment, the plurality of remote servers 110 may be updated and the application 104a or another application (not pictured) on the server computer 102 may receive/retrieve information from the plurality of remote servers, as well as receiving information from customers who are revising or creating new profiles. In an embodiment, the system 100 is configured to receive real-time updates from the plurality of remote servers 110 which enables the system 100 to provide the most current information from, for example, the Orange Book and insurance providers. As used herein, a “real-time” update comprises an updated that is pushed to/retrieved by the computer system 100 from the plurality of remote servers 110 within a predetermined timeframe of the updated information being available. In some embodiments, this may comprise a remote server of the plurality of remote servers 110 sending a message to the computer system, for example, the application 104a, that new or revised (updated) information is available. In alternate embodiments, the application 104a may be configured to ping or message some or all of the plurality of remote servers 110 in order to determine when updated/new information is available so that the information can be received by the application 104a and employed in the associated systems and methods discussed herein. By updating the information used to perform the methods disclosed herein in real-time, the most current information may be used to determine at least therapeudic equivalents and insurance coverage, in addition to other information associated with and provided to the application 104a by the plurality of remote servers 110. It is understood that “updated information” as used herein indicates deletion, modification, and addition, of information associated with each of the plurality of remote servers.

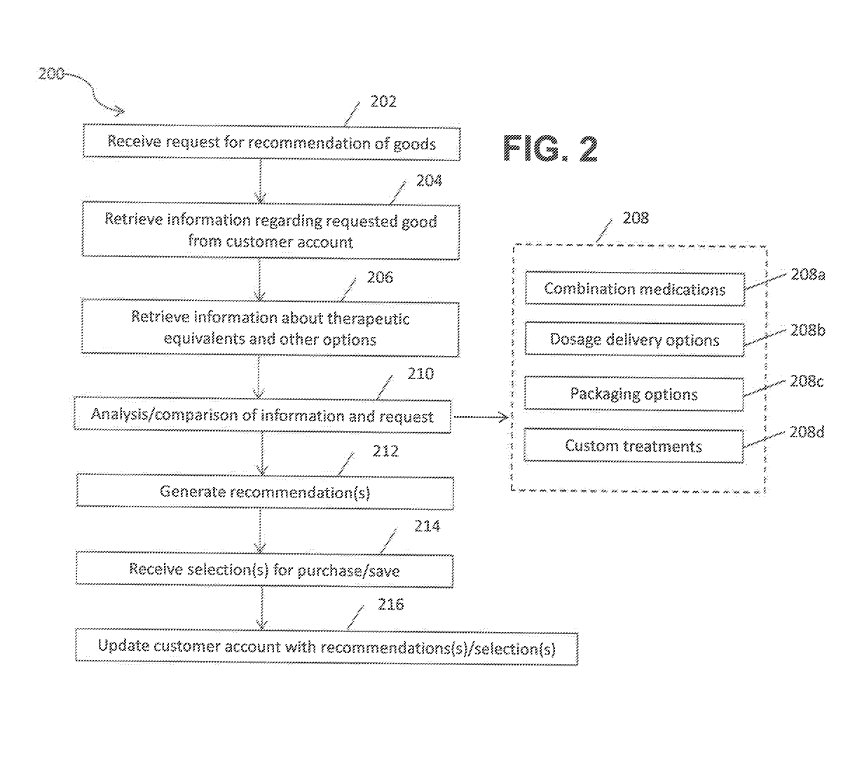

FIG. 2 is a flow chart for method 200. At block 202, an application, for example application 104a in FIG. 1, receives a request for a recommendation of goods. In an embodiment, the request received at block 202 may be for a single prescription medication or a plurality of prescription medications, or for assistance/recommendations for a health condition for which medication may have not yet been prescribed, or for assistance/recommendations for preventing a health condition. At block 204, in response to receiving the request at block 202, the application 104a may retrieve information, for example, from the server computer 102 as shown in FIG. 1. The information retrieved may be associated with the requested good(s). This information may comprise a health condition associated with the requested good(s) for which a medication has been prescribed, as well as allergies, preferences, and other information that may be relevant to recommending goods to the customer for purchase. At block 206, the application 104a may retrieve information regarding therapeutic equivalents or other alternatives or supplements to medication such as consumables, vitamins, and minerals. The information retrieved at block 206 may be retrieved from the plurality of remote servers 110 as indicated in FIG. 1. At least some of the servers of the plurality of remote servers 110 may be associated with insurance providers, government agencies (for Orange Book updates), pharmaceutical manufacturers, health product manufactures, and other entities that supply information to the system 100. At block 210, the application 104a may analyze and/or compare the information retrieved at blocks 204 and 206 as well as the request received at block 202.

Subsequent to the analysis and/or comparison by the application 104a, the application 104a generates a recommended goods list or matrix based upon the comparison and analysis of information about the requested good, which may be a prescription medication, and potential replacement or supplement goods. If a plurality of prescription medications is submitted in the request for recommendation, a plurality of lists/matrixes may be generated as discussed herein. A list generated according to certain embodiments of the present disclosure may comprise the alternatives' names or other identifiers and the customer can select a recommended good's name or identifier and receive further information. A matrix generated according to certain embodiments of the present disclosure may display various fields including those used in the comparison such as price points, dosages, state law, packaging options, storage requirements/suggestions, dosage delivery options, and availability within a defined proximity of the customer's location. In some embodiments, the displayed fields may be based upon a customer preference as indicated in either the request at block 202 or in the customer's profile.

In some embodiments, the information retrieval at block 210 may also comprise an analysis at block 208 to determine if the requested goods (if more than one good is requested) could be substituted by a single medication at block 208a or to review dosage delivery options at block 208b, packaging options at 208c, or to determine if the request is for a custom treatment or formulation including a biologic. The customer's location may be retrieved from the associated profile, or may be separately selected during the request process if, for example, the customer is at work, on vacation, or otherwise in a location or will be in a location in the future that would make an alternate pickup location desirable.

At block 212, a plurality of recommendations are displayed which may present as options including different price points, dosage delivery methods, and refill options. The application 104a may receive a selection of a good or goods for purchase at block 214, based upon the plurality of recommendations displayed at block 212, and may update the customer account at block 216 with the purchased item(s) and/or the recommended items. At block 218, and as discussed below the system 100 may communicate with a remote server, for example, an insurance provider's server that is one of the plurality of servers 110 from FIG. 1, in order to adjudicate an insurance claim for a selected purchase.

In an embodiment, the plurality of recommendations are displayed at block 212 in a manner that includes not only the price point, but also the insurance coverage (if any) provided for each of the plurality of recommendations, this may be referred to as the “covered price point.” Claim adjudication is the term used herein to describe the application of insurance coverage from at least one plan to a product, and may be displayed to the user as the covered price point. This information may be provided for one or more insurance providers associated with a customer's account/profile. The selection may result in claim adjudication through the application 104a, wherein, in response to the application 104a receiving the selection not only for a recommendation but also for the insurance (if more than one insurance provider or plan is associated with the customer's account/profile). In this example, the application 104a is specifically configured to communicate with at least one insurance server of the plurality of remote servers 110, both to download and update coverage information on a dynamic, real-time, basis and also to communicate the selection information so that the claim can be adjudicated in a one-step process upon selection. In an embodiment, a customer may select at least one insurance provider associated with their account to determine how much of the cost would be covered by insurance, and in an alternate embodiment, the customer may select more than one insurance provider to compare different insurance coverage. In one example, the insurance providers selected for this comparison are all associated with the customer account, and in another example only one insurance provider is associated with the customer account. That is, a customer may be able to determine the differences in coverage between insurance providers if the customer is covered, or if the customer is thinking about changing plans or using a different plan associated with the customer account. The system 100 is configured to communicate with a remote server of the plurality of remote servers 110 in order to adjudicate the claim upon the customer's purchase of the product(s) so that the customer does not have to submit a separate claim for reimbursement. In an alternate embodiment, the available FSA coverage may also be provided to a customer when recommended products are displayed. In some embodiments, the customer or the application 104a may set a reminder for re-ordering a selection, this preference may be set in the customer profile by the customer or as a default, and may be set based upon the dosage, prescription quantity, and/or quantity purchased, as well as any rules associated with the insurance provider(s) associated with the customer profile.

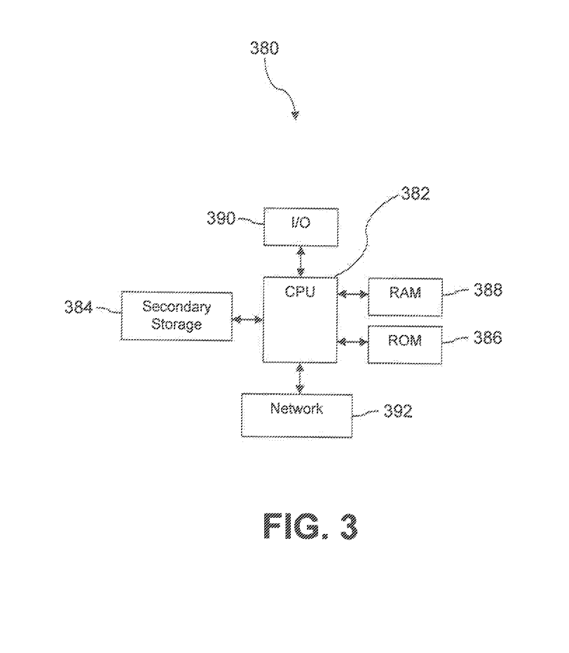

FIG. 3 illustrates a computer system 380 suitable for implementing one or more embodiments disclosed herein. The computer system 380 may be similar to the system 100 in FIG. 1. In one embodiment, the method 200 discussed above may be implemented in a form substantially similar to that of the computer system 380. The computer system 380 includes a processor 382 (which may be referred to as a central processor unit or CPU) that may be similar to the processor 106 in FIG. 1 and that is in communication with memory 104 devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions such as those comprised by the application 104a in FIG. 1 onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media. I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 382 executes instructions, codes, computer programs, and scripts such as the application 104a which the processor 382 accesses from hard disk, floppy disk, optical disk (these various disk based systems may all be considered secondary storage 384), ROM 386, RAM 388, or the network connectivity devices 392. While only one processor 382 is shown in FIG. 3 and FIG. 1 (106), multiple processors such as 382 or 106 may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer 380 is turned on and operational, the dynamic RAM stores information that is written to it and updates the information in real time. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

The methods, computer systems, computer networks, apparatus, servers, processors, dedicated processors, and other computer components disclosed herein provide a solution necessarily rooted in computer technology to overcome a problem specifically arising in the realm of computer networks, e.g., problems related to establishing and maintaining communications between computer systems updated by private entities, public entities, and ultimately employed in combination to provide healthcare options and resources. The disclosed solutions, which involve systems and methods of providing at least therapeutic equivalents via the embodiments disclosed herein, enable said embodiments to overcome problems such as overpaying for medication due to insurance selection or lack of knowledge of generic options, a lack of awareness as to what non-prescription resources, food, herbs, vitamins, minerals, and OTC medications, can be used in combination either as preventive or corrective measures in addition to or instead of prescription medication. These solutions do not simply utilize the Internet and/or other information networks. Instead, the disclosed solutions solve problems arising due to the structural nature of computer networks utilized by government entities, insurance companies, and healthcare companies for to provide sustainable, comprehensive healthcare solutions to customers. By utilizing the recommendation system disclosed herein, including the disclosed methods, computer systems, computer networks, apparatus, servers, processors, dedicated processors, and other computer hardware utilize a specific technique necessarily rooted in computer technology for providing sustainable, comprehensive healthcare solutions to customers.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A health care recommendations system comprising:
a server computer comprising a memory, a processor, and an application executable by the processor that causes the application to:
receive a request for a recommendation of at least one good, wherein the request is associated with a customer profile, wherein the customer profile comprises a plurality of prescription medicines prescribed to a customer associated with the customer profile;
retrieve a plurality of information from at least a plurality remote servers separate from the server computer, wherein the plurality of information is associated with a plurality of goods, wherein the plurality of goods comprises prescription medicines and over-the-counter medicines;
analyze at least the request, the customer profile, and the plurality of information to determine a subset of the plurality of goods, wherein the subset of the plurality of goods comprises goods corresponding to the request for the recommendation at least one good;
display a plurality of recommendations comprising the subset of the plurality of goods comprising at least one price point determined based upon the application applying a plurality of rules associated with an insurance provider associated with the customer profile;
receive a purchase request for at least one of the subset of the plurality of goods; and
update the customer profile with at least the purchase request.

2. The system of claim 1, wherein the plurality of information comprises prices points before insurance coverage is applied, price points after insurance coverage is applied, dosages, weights, volumes, and nutritional information associated with the plurality of goods.

3. The system of claim 1, wherein the customer profile comprises a customer address, a customer email address, at least one insurance provider, at least one social media profile, allergy information, age, marital status, education, and employment.

4. The system of claim 1, wherein the application sets a plurality of reminders for at least one of re-ordering or re-purchasing the at least one of the subset of the plurality of goods.

5. The system of claim 1, wherein the plurality of goods further comprises vitamins, minerals, perishables, and wherein the prescription medicines comprise custom-blended medicines, biologics, interchangeable biologics, and follow-on biologics.

6. The system of claim 1, wherein at least some goods of the plurality of goods are associated with at least two forms of packaging.

7. The system of claim 1, wherein at least some goods of the plurality of goods are associated with at least two forms of dosage delivery.

8. A health care recommendation system comprising:
a server computer comprising a memory, a processor, and an application executable by the processor that causes the application to:
receive a request for a recommendation of goods, wherein the request is associated with a customer profile, wherein the customer profile comprises a plurality of prescription medicines prescribed to a customer associated with the customer profile;
retrieve a plurality of information from a plurality of servers, wherein the server computer is one of the plurality of servers, and wherein at least some of the plurality of servers are remote servers, wherein the plurality of information is associated with a plurality of goods, wherein the plurality of goods comprises prescription medicines, over-the-counter medicines, vitamins, minerals, and perishables, wherein the prescription medicines comprise brand name and generic medicines;
compare a price point associated with a prescription medicine prescribed to the customer and a price point of a good of the plurality of goods, wherein the at least one good comprises a brand name medicine, a generic medicine, a vitamin, a mineral, a perishable, and an over-the-counter medicine;
compare a health benefit associated with the prescription medicine prescribed to the customer and a price point of a good of the plurality of goods, wherein the at least one good comprises a brand name medicine, a generic medicine, a vitamin, a mineral, a perishable, and an over-the-counter medicine;
recommend at least one of the brand name medicine, the generic medicine, the vitamin, the mineral, the perishable, and the over-the-counter medicine;
receive a purchase request for the at least one recommended good; and
update the customer profile with at least the purchase request.

9. The system of claim 8, wherein the plurality of information comprises prices points, dosages, weights, volumes, and nutritional information associated with the plurality of goods.

10. The system of claim 8, wherein the customer profile comprises a customer address, a customer email address, at least one social media profile, allergy information, age, marital status, education, and employment.

11. The system of claim 8, wherein the application further updates the customer profile with the recommendation of the at least one of the brand name medicine, the generic medicine, the vitamin, the mineral, the perishables, and the over-the-counter medicine.

12. The system of claim 8, wherein the application sets a plurality of reminders for at least one of re-ordering or re-purchasing the recommended good.

13. The system of claim 12, wherein the application sends the plurality of reminders at periodic intervals, wherein the periodic intervals are based upon at least one of the number of doses purchased of the at least one brand name medicine, the generic medicine, the vitamin, the mineral, and the over-the-counter medicine.

14. The system of claim 13, wherein the periodic intervals are based upon a quantity purchased of the perishables.

15. The system of claim 8, wherein the application receives a second request, wherein the second request comprises a message to send a plurality of reminders for at least one of re-ordering or re-purchasing the recommended good.

16. The system of claim 8, wherein the health benefit comprises at least one of lowering or raising the results of at least one diagnostic test or a symptom of an adverse health condition.

17. The systems of claim 8, wherein the perishables comprise produce, animal products, produce derivatives, animal product derivatives, and grains.

18. A system for recommending health care options, comprising
a server computer comprising a processor, a memory, and an application executable by the processor that causes the application to:
receive a request for a recommendation of goods, wherein the request is associated with a customer profile, wherein the customer profile comprises a plurality of prescription medicines, and wherein each prescription medicine of the plurality of prescription medicines is associated with at least one health condition;
retrieve a plurality of information from a plurality of servers, wherein the server computer is one of the plurality of servers, and wherein at least some of the plurality of servers are remote servers, wherein the plurality of information is associated with a plurality of goods, wherein the plurality of goods comprises prescription medicines and over-the-counter medicines;
analyze the request, the customer profile, and the plurality of information to determine a subset of the plurality of goods, wherein the subset of the plurality of goods comprises goods corresponding to the request for the recommendation of goods;
recommend the subset of the plurality of goods, wherein each good of the subset of goods is associated with improving the at least one health condition corresponding to the goods in the recommendation request;
receive a purchase request for at least one of the subset of the plurality of goods; and
update the customer profile with at least the purchase request.

19. The system of claim 18, wherein the customer profile comprises health condition information for more than one customer, and wherein the plurality of prescription medicines is associated with the more than one customer.

20. The system of claim 18, wherein the subset of the plurality of goods comprises goods corresponding to the request for the recommendation of goods, wherein at least one good of the subset of the plurality of goods corresponds to two prescription medications of the plurality of prescription medications prescribed to the customer.
